(19) United States
(12) Patent Application Publication
(10) Pub. No.: US 2009/0148268 A1
(43) Pub. Date: Jun. 11, 2009

(54) MIXER FOR JET SPRAY

(76) Inventor: Fabrizio Nobili, San Vittore (CH)

Correspondence Address: SEED INTELLECTUAL PROPERTY LAW GROUP PLLC, 701 FIFTH AVE, SUITE 5400, SEATTLE, WA, 98104, US

(21) Appl. No.: 12/324,426

(22) Filed: Nov. 26, 2008

(30) Foreign Application Priority Data
Nov. 30, 2007 (EP) 07023225.1

(51) Int. Cl. F01B 25/00; F16K 11/078; F16K 31/02; F16K 31/08

(52) U.S. Cl. 415/10; 137/625.4; 251/129.11; 251/65

(57) ABSTRACT

Mixer for a jet spray including a regulator equipped with hot and cold water inlets, a mixed water outlet and shutters arranged between the outlet and, respectively, the hot water inlet and the cold water inlet; motorized means for actuating the shutters; an interception assembly, comprising a manifold mounted axially on the outlet of the regulator, at least one outlet, and an interceptor for blocking and unblocking the supply of water towards the outlet; and a substantially box-shaped outer housing comprising holes at which the inlets of the regulator and the outlet of the interception assembly are positioned for the hydraulic connection of the inlets and the outlet to respective hydraulic pipes

### BACKGROUND

1. Technical Field

The present invention refers to a mixer for a jet spray, comprising a regulator equipped with hot and cold water inlets, with a mixed water outlet and with shutters arranged between the outlet and, respectively, the hot water inlet and the cold water inlet to regulate the temperature and the flow rate of the water.

In particular, the present invention refers to a mixer for a jet spray applicable to bathtubs, showers, sinks, and similar jets used in the home.

2. Description of the Related Art

As is well known to a man skilled in the art, a mixer for regulating the supply of fluid, i.e., a mixer for supplying and regulating cold and hot water, is hydraulically connected to a jet spray through which the water mixed in temperature and in flow rate is dispensed.

The mixer can be installed on a wall under the kitchen sink, sometimes projecting from the wall above the sink or positioned on the sink.

In particular, the mixer comprises a regulator equipped with hot and cold water inlets, with a mixed water outlet and with shutters arranged between the outlet and, respectively, the hot water inlet and the cold water inlet to regulate the temperature and the flow rate of water. The hot and cold water inlets can be hydraulically connected to wall-mounted hot and cold taps, and the outlet is connected, for example through a flexible pipe, to the jet spray.

The mixer is actuated by a lever mounted on the washbasin or on a shower panel for the mechanical actuation of the shutters that allows the flow rate and the temperature of the water to be regulated according to the amount of hot water and cold water that flows through the shutters and towards the outlet of the regulator.

The actuation lever is for example adjustable in the clockwise direction to increase the temperature of the water, i.e., to allow a greater flow of hot water through a first shutter, in the counterclockwise direction to decrease the flow of hot water and consequently decrease the temperature of the water, allowing a greater flow of cold water through the second shutter, or adjustable according to different inclinations to increase or decrease the flow rate, simultaneously opening or closing both of the shutters.

The water jet is also adjustable into a central jet or into a rain-type jet. In this case, the jet spray is equipped with a mechanical deviation button of the flow towards a plurality of peripheral nozzles of the jet spray or towards a central nozzle thereof. Substantially, the mechanical button controls a valve that selectively interrupts the path of fluid from the outlet of the regulator towards the nozzles or towards the central nozzle. In this case, the valve forms part of the jet spray and not of the mixer.

Moreover, the water jet is adjustable into other dispensing modes, for example in the case of showers equipped not only with manual shower head but also with a fixed central ring and with a hydromassage jet, the water jet is selectively dispensed through, indeed, the ring, the shower head or the hydromassage jet. In this case hydraulic connection tubes are arranged between the mixer and the jets and different actuation buttons are provided on the shower panel for mechanically activating regulation means, for example electrovalves, associated with respective hydraulic connection tubes.

As is clear, the installation of a mixer of the aforementioned type is actually complex due to the different structure of the water installations with which the mixer can be associated, so much so that it has to be explicitly adapted to a specific sink or bathtub or shower panel, as well as to the desired aesthetic characteristics.

Moreover, such a mixer does not include all of the control commands of the jet but mainly carries out the functions of regulating the temperature and the flow rate. Consequently, other mechanical components are foreseen, for example in the head of the jet spray for the deviation of the flow towards the peripheral nozzles or the central nozzle or else on the shower panel to actuate the hydromassage, the central ring or the manual shower head, influencing the appearance of the jet spray or of the shower panel due to the bulk of the mechanical components. For example, the insertion of a deviation valve of the flow in the head of the shower head inevitably means that the shower head is of a sufficient size to contain the deviation valve and the relative activation command.

The technical problem at the basis of the present invention is to devise a mixer for a jet spray for regulating the temperature and the flow rate of the water easily applicable not only to a sink but also to a bathtub or to a shower panel, said mixer being compact and extremely simple to actuate, substantially centralizing all the means for regulating the flow and overcoming the limitations that the mixers according to the prior art suffer from.

### BRIEF SUMMARY

The idea at the basis of the present invention is to incorporate into a monoblock having a substantially box-shape and small size, a plurality of means for controlling the flow, including a temperature and flow rate regulator, an opening and closing interceptor and electronically controlled motorized means for actuating the regulator and the interceptor, as well as incorporating electrical actuation commands of the motorized means directly inside the housing or associating them with it electronically.

Based upon such an idea of solution, the aforementioned technical problem is solved by a mixer for jet spray characterized in that it comprises

a regulator equipped with hot and cold water inlets, with a mixed water outlet and with shutters arranged between the outlet and, respectively, the hot water inlet and the cold water inlet;

motorized means for actuating the shutters;

an interception group, comprising a manifold mounted axially on the outlet of the regulator, at least one outlet, and an interceptor for blocking and unblocking the supply of water towards the outlet;

a substantially box-shaped outer housing comprising holes at which the inputs of the regulator and the outlet of the interception group are positioned for the hydraulic connection of the inlets and of the outlet to respective hydraulic pipes.

### BRIEF DESCRIPTION OF THE SEVERAL VIEWS OF THE DRAWINGS

FIG. 1A represents a perspective view of a mixer according to the present invention;

FIG. 1B represents a perspective view in partial section of a mixer according to the present invention;

FIG. 2A represents a perspective exploded view of a mixer according to the present invention;

FIG. 2B represents a perspective view of an interception assembly of the mixer according to the present invention;

FIG. 2C represents a perspective view of a regulator according to the present invention;

FIG. 3 represents a perspective view of another embodiment of a mixer, according to the present invention;

FIG. 3A represents a perspective view in partial section of the mixer of FIG. 3;

FIG. 4 represents a perspective exploded view of the mixer of FIG. 3;

FIG. 5 represents a section view of a regulator and of the electric motors of the mixer of FIG. 3;

FIG. 6 schematically represents a temperature sensor of the mixer according to the present invention.

### DETAILED DESCRIPTION

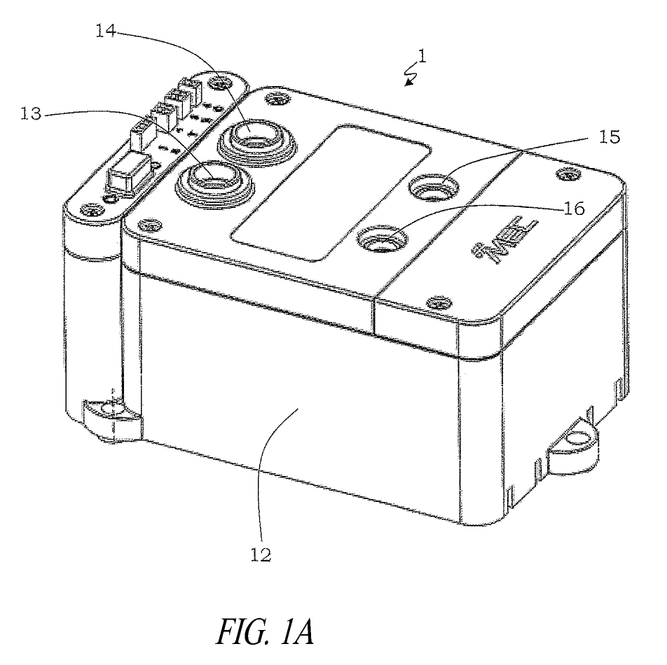

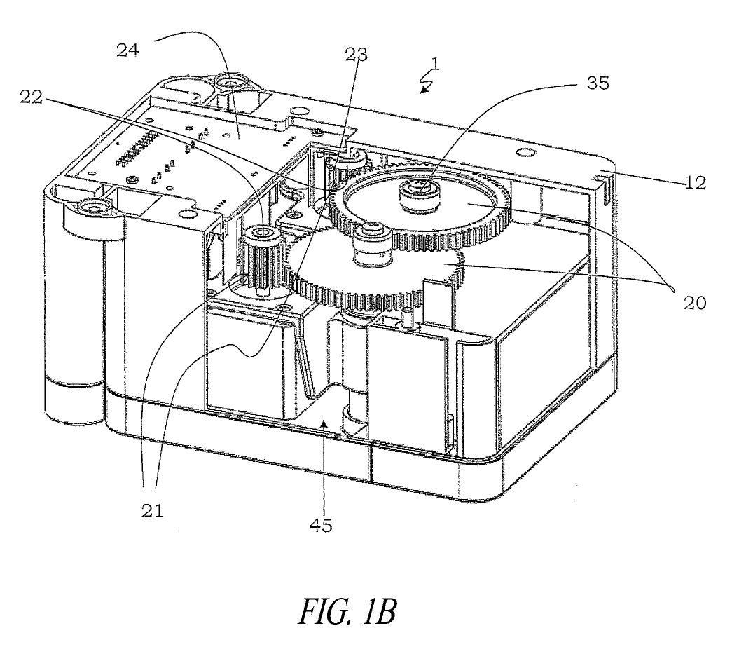

With reference to the attached FIG. 1A a mixer for jet sprays for bathtubs, showers, sinks, hydromassage showers and baths and similar shower heads is schematically represented and globally indicated with reference number 1.

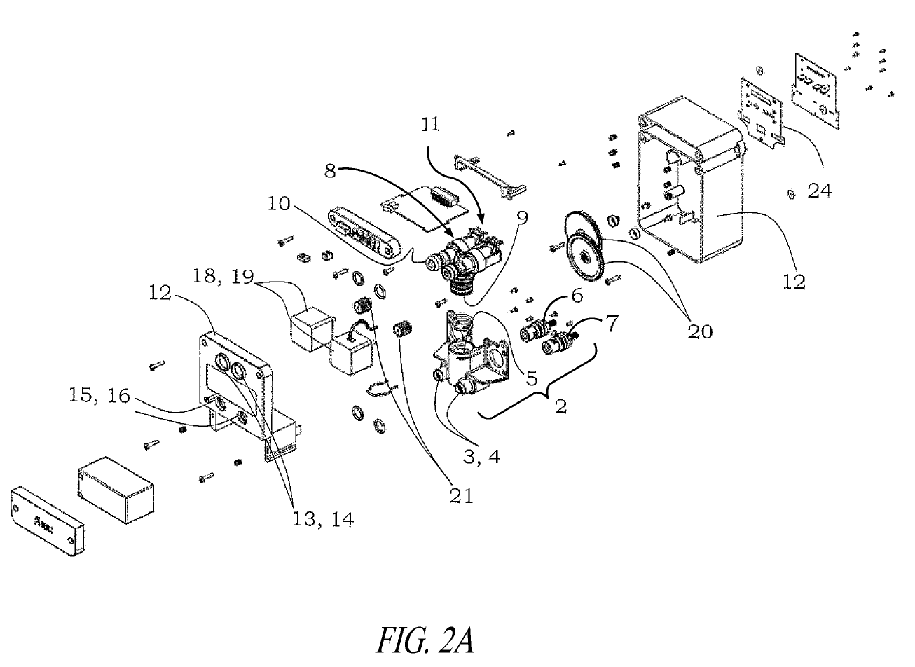

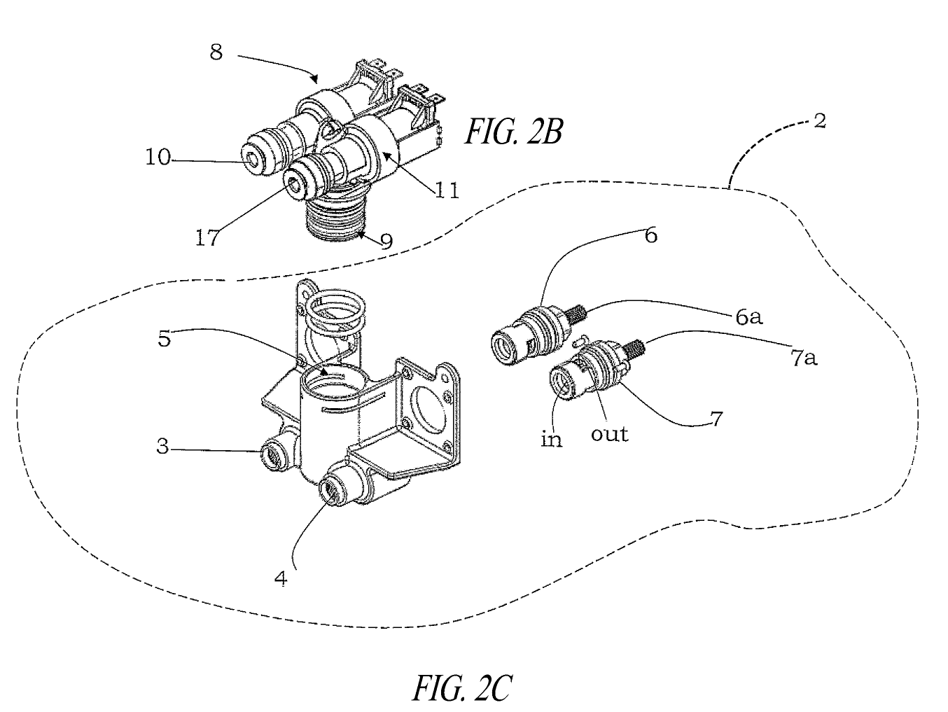

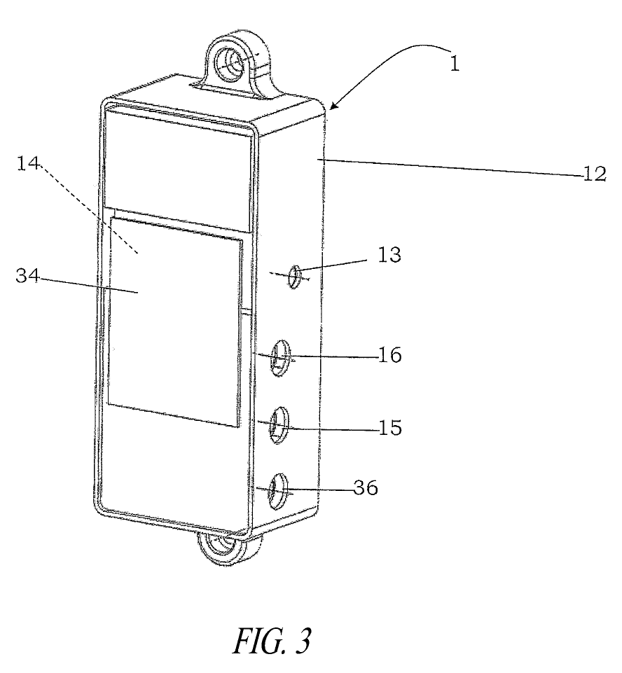

In particular, with reference to FIG. 2A, the mixer 1 comprises a regulator 2 connectable to flexible hydraulic pipes for supplying cold water and hot water, and equipped with means for regulating the temperature and the flow of water, providing the partialization of the flow coming from the respective hot water and cold water inlets.

The regulator 2 comprises a hot water inlet 3 and a cold water inlet 4, respectively connectable to the flexible pipes for supplying hot and cold water, an outlet 5 for mixed water and shutters 6, 7 (FIG. 2C), substantially arranged between the outlet 5 and, respectively, the inlet 3 and the inlet 4.

The mixer 1 also comprises an interception assembly 8 connected to the regulator so as to receive water already mixed to a predetermined temperature and amount by the regulator 2, and comprising an interceptor 11 (FIG. 2B) for blocking and unblocking the supply of mixed water towards an outlet 10 of the interception assembly 8.

The outlet 10 is connected to the jet spray through a flexible pipe that ends substantially in the head of the shower head or of the jet spray. The interceptor 11 is preferably an on-off safety electrovalve controlled by a respective coil.

According to the present invention, the regulator 2 and the interception assembly 8 are connected in a single block 45 (FIG. 1B) or mixing monoblock that is structurally independent and having low bulk. Such a monoblock is suitable for being enclosed by an outer housing 12 easily applicable to a shower panel, to a kitchen or bathroom sink, as shall become clear from the following description.

In particular, the interception assembly 8 comprises a manifold 9 that is mounted axially on the outlet 5 of the regulator 2 so that the interception assembly 8 and the regulator 2 are substantially included in the mixing block 45 that receives hot water and cold water and controls, in output, the emission of water already regulated in temperature and amount, through the interceptor 11.

The outer housing 12 is substantially box-shaped and comprises holes 13, 14, 15, 16 (FIG. 1A) at which the inlets 3, 4 of the regulator 2 and the outlet 10 of the interception assembly 8 are positioned for the hydraulic connection of the inlets 3, 4 and of the outlet 10, respectively to the flexible hydraulic pipes for supplying hot and cold water and to the pipe for connecting to the jet spray.

The outer housing 12 is made from electrically insulating material, impermeable, in particular equipped with one or more walls from which the inlets 3 and 4 and the outlet 10 flow through the holes 13, 14, 15, 16.

More specifically, the connection between the interception assembly and the regulator 2 not only allows a mixer to be made with minimum size but is also structurally configurable, for example according to a substantially elongated and flattened or compact and box-shaped structure, adapting to the most widely varying bathroom and kitchen applications.

For example, in order to build the mixer 1 into a seat of a very thin shower panel, the manifold 9 and the outlet 5 are mounted axially and aligned, substantially coplanar to the fluid paths between the inlets 3, 4 of the regulator 2 and the outlet 5 and between the manifold 9 and the outlet 10; in this case the mixing block 45 is substantially parallelepiped and flattened.

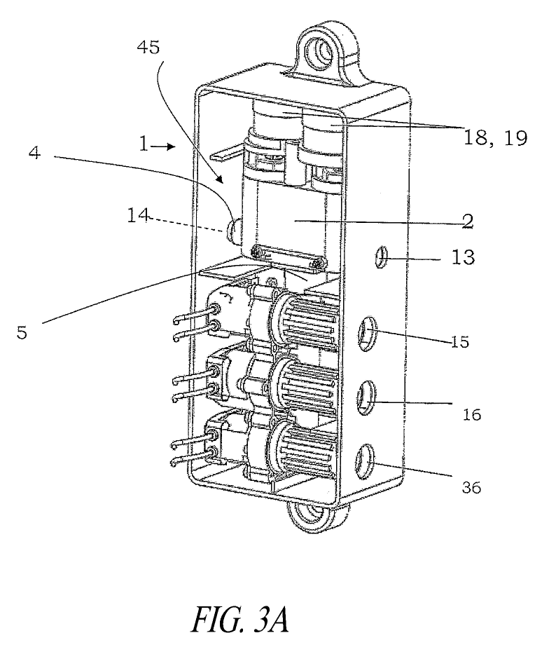

FIG. 3 schematically shows the flattened configuration of the mixer 1, comprising a substantially parallelepiped and flattened housing 12 with opposite side inlets 13 and 14 and side outlets 15, 16, 36. As shall become clearer from the following description, such a flattened configuration is particularly advantageous for very thin shower panels suitable for being built in, for example into the wall.

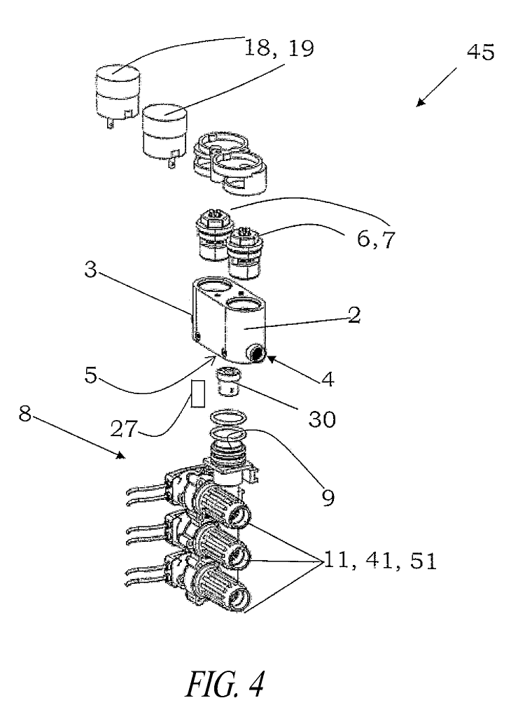

FIG. 3A represents a perspective view in partial section of the mixer of FIG. 3 and in particular shows how the manifold of the interception assembly 8 is inserted in the outlet 5 of the regulator 2. FIG. 4 represents a perspective exploded view of the mixer of FIG. 3 and in particular highlights how, not only are the regulator and the interception assembly 8 substantially aligned but the electric motors 18 and 19 are also connected to the shutters of the regulator 2 to form a structure that is overall flattened and elongated.

In order to apply the mixer 1 in a different box-shaped seat, the manifold 9 and the outlet 5 are mounted axially but the outlet 5 forms a first deviation of the fluid coming from the inlets 3, 4 of the regulator 2 and the manifold 9 forms a second deviation of the fluid intended for the outlet 10. Such a configuration, also indicated as box-shaped, is schematically represented in FIG. 1A.

The mixer 1 is electrically actuated and comprises electric actuation motors 18, 19 of a respective shutter 6, 7 of the regulator.

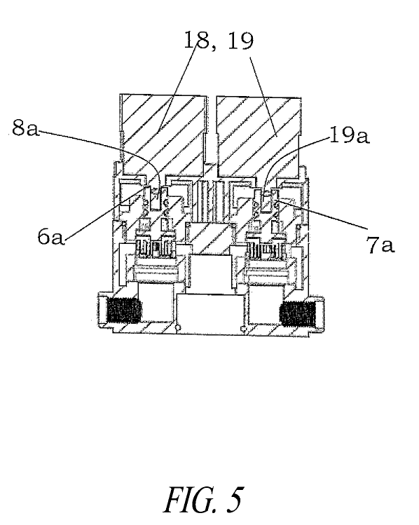

In the flattened configuration of the mixer 1, such electric motors 18, 19 have a rotation shaft 18a, 19a mounted axially and fixedly to a rotation pin 6a, 7a of the respective shutter 6, 7, as schematically represented in the section of FIG. 5. It should be noted that the motors 18, 19 are located within the flattened and elongated housing 12, substantially aligned with the interception assembly 8 and with the regulator 2.

The electric motors 18, 19 comprise a ratio motor to reduce the rotation speed of the rotation pin 6a, 7a of the shutter with respect to the rotation speed of the motor 18, 19.

In the box-shaped configuration of the mixer the electric motors 18, 19 are aligned with the interception assembly 8 but are coupled with the shutters 6, 7 through reducing gears 20, 21. In particular, first reducing gears 21 are mounted on respective rotation pins 6a, 7a of the shutter and second reducing gears 20 are mounted on the rotation shaft of the respective electric motors 18, 19.

The mixer 1 according to the present invention is equipped with sensors comprising a control sensor of the operation of the motor, a temperature sensor and a flow sensor.

In particular, a magnet 22 (FIG. 1B) with n poles is mounted axially on a reducing gear 21 associated with the shaft of the electric motor and the control sensor 23 is fixed near to the magnet 22, for example fixed firmly to the housing 12.

The angular displacement of the electric motor shaft corresponds to an angular displacement of the magnet 22 and to a detection of a corresponding number of poles through the magnet 22. Preferably, the magnet has 16 poles and the sensor detects 16 different positions of the electric motor 18, 19.

As schematically shown in FIG. 4, the mixing block 45 comprises a turbine 30, arranged between the outlet 5 of the regulator 2 and the manifold 9 of the interception assembly 8, comprising a plurality of blades on which a respective magnet is fixed. The flow sensor 27 is mounted or otherwise fixed near the turbine 30, for example firmly connected to the housing 12 to detect the magnets associated with the blades and measure the frequency of rotation of the turbine 30. The flow sensor 27 therefore allows the amount of water emitted upstream of the outlet 10 to be measured.

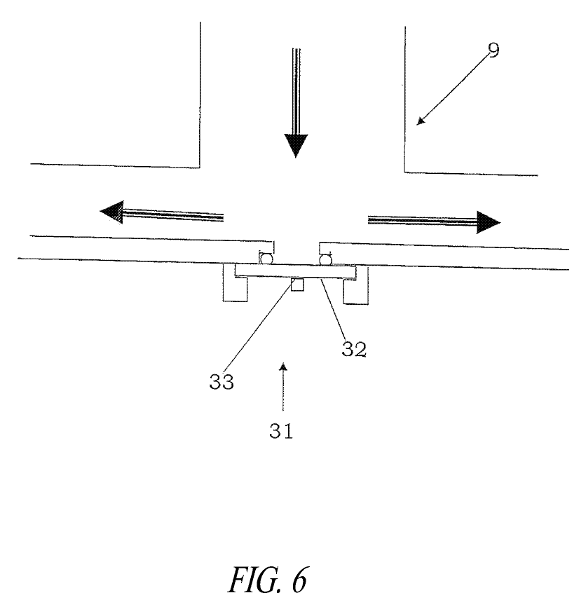

The temperature sensor 31 comprises a plate 32 having a support surface on which a temperature measurer 33 is fixed, as schematically represented in FIG. 6. The plate 32 is arranged inside the manifold 9 to receive the flow of mixed water on the surface opposite the support surface and to insulate the temperature measurer from such a flow. The plate 32 is for example inserted into a seat suitably formed in the manifold 9. The plate 32 is made from ceramic or a similar electrically insulating but heat conducting material.

An electronic control board 24 (FIGS. 1B, 2A) is connected to the sensors; preferably, the control sensor is directly mounted on the electronic control board 24 with the gears of the drive shaft arranged substantially facing the electronic control board 24.

The interception assembly 8 according to the present invention comprises at least one second outlet 17 (FIG. 2B) and at least one second interceptor 41, 51 (FIG. 4) for blocking and unblocking the supply of water towards the second outlet 17. The first interceptor 11 and the second interceptor 41 are on-off electrovalves selectively actuated, to unblock the supply of water towards the respective outlet 10, 17, or actuated simultaneously to block the supply of water into the manifold 9.

As schematically represented in FIG. 3, there is nothing to prevent the use of an interception assembly 8 with three or more interceptors 11, 41, 51 to block/unblock the flow of water towards respective outlets 15, 16 and 36. Such interceptors, as shall become clear from the following description, can be selectively actuated to unblock and block the flow of water regulated in temperature and amount, for example, to select the jet in a shower equipped with a fixed ring connected to the outlet 15, with a hydromassage jet connected to the outlet 16 or with a shower head connected to the outlet 36.

The mixer 1 also comprises a power supply battery electrically connected to the electronic control board 24 and to electric motors 18, 19, to the control sensors 23, to the temperature sensors 31, to the flow sensors 27 and to the battery.

The mixer 1 comprises a user interface 34, for example a keyboard or a touch screen interface, for commanding the regulator 2 and the interception assembly 8, electrically connected to the electronic control board 24. The user interface 34 also displays the values measured by the sensors of the mixer.

With reference to the attached figures the mixer 1 is described hereafter in greater detail. The mixer 1 is a monolithic body or monoblock for fittings installed near to hydraulic endings for distributing water, cold and hot respectively, for example fixed directly to the wall or in a space hidden in the shower panel, preferably between the shower panel and the wall.

The mixer 1 can also be installed below a kitchen sink, not represented since it is conventional, which is normally positioned at and above the hydraulic endings. The mixer can also be installed in a different location, for example above the washbasin or else hidden in a suitable recess made in the wall and possibly closed by a hatch. Similarly, the mixer can be installed below a basin or else at a bathtub.

The mixer includes the regulator 2 comprising the inlets 3, 4 for supplying fluid respectively connected to the hydraulic endings of a hydraulic distribution network of cold and hot water through flexible pipes, not represented because conventional.

The inlets 3, 4 are in fluid communication with the dispensing outlet 5 situated in the regulator 2, for example in an intermediate equidistant position with respect to the inlets 3, 4.

The shutters 6, 7 are arranged on the fluid path between the fluid supply inlets 3, 4 and the outlet 5 and they are for intercepting fluid but are also able to regulate its flow rate.

The shutters 6, 7 are for example valves equipped with a central stem inserted in a practically cylindrical seat having an inlet opening for the fluid and an outlet thereof (see, e.g., FIG. 2C). The valve is opened when the position of the stem does not create interference with the opening and is closed when the stem completely blocks the opening. The intermediate angular displacements of the stem between the closed position and the open position allow the flow rate of the fluid to be regulated.

More specifically, a first valve 6 is housed in a respective seat formed in the regulator 2 for regulating the flow rate of cold water and, similarly, a second valve 7 is housed in a corresponding seat formed in the regulator 2 for regulating the flow rate of hot water.

The valves 6, 7 have progressive actuation and are equipped with respective command stems 6a, 7a projecting outside from the valve seat and made to rotate as a unit with a respective gear 20 clearly visible in the example of FIG. 1B.

The electric motors 18, 19 for actuating the valves 6, 7 each comprise its own rotation shaft firmly connected with a corresponding gear 21 for engaging with a respective gear 20 of the valves 6, 7.

Each electric motor 18, 19 is for example of the direct current ratio motor type and is electrically controlled by a respective power outlet of the electronic control board 24.

The electric motor 18 makes the control gear 21 rotate, the toothing of which is engaged in the toothing of the gear 21 firmly connected to the stem of the valve 6.

Similarly, the electric motor 19 makes the control gear 21 rotate, the toothing of which is engaged in the toothing of the gear 20 firmly connected to the stem of the valve 7. Between the gears 20 and 21 a predetermined transmission or reduction ratio is provided, allowing each ratio motor to regulate the opening of the relative valve 6, 7 with particular precision.

Therefore, each electric motor 18, 19 regulates the opening of the respective valve 6, 7 and, consequently, the flow rate of the fluid flow of the cold and hot water, respectively.

The electronic control board 24 is connected to the motorized actuation means 18, 19 of the valves 6, 7 and is able to be electrically connected to an electric command arranged directly on the jet spray, on the diffuser of the sink, on the shower panel or on the bathtub. The electrical command can advantageously be incorporated in the mixer group and able to be actuated through the user interface mounted directly on the coating 12 of the mixer.

An electric signal produced by the actuation of the command is processed by the electronic control board 24. The command has progressive actuation and thus allows the flow rate of the fluid flow to be regulated with high precision. A second electric command allows the temperature of the fluid to be regulated.

In a preferred embodiment the first and second electric commands are connected to the electronic control board 24 through an electric connection. In particular, in the case in which such electric commands are mounted on the shower head and not included in the interface of the mixer, they are electrically connected through electric wires that run inside a flexible pipe that joins the shower head to the mixer and suitably insulated inside a sheath.

The electronic control board 24 is housed in a watertight portion of the housing 12 of the mixer 1. In particular, the housing 12 is made from a rigid plastic synthetic material, preferably transparent to allow the components of the mixer 1 to be quickly seen and inspected in the maintenance step. On one side of the housing 12 the housing portion of the electronic control board is provided; the electronic control board is fed with mains electricity through an outer transformer inserted in a wall socket foreseen near to the hydraulic endings, not represented because it is per se conventional.

Respective electrical connections are foreseen between the electronic control board 24 and each of the electric motors 18, 19, as well as between the electronic control board 24 and each of the commands.

It is worth noting that a wireline connection is not strictly necessary for the purposes of the present invention since the commands can be electrically coupled with the electronic control board through a wireless connection.

In the case in which such commands are directly positioned on the shower head, the latter can be equipped with a device for transmitting radio frequency signals whereas the electronic control board 24 can comprise a receiver of such radio frequency signals.

The electronic control board 24 comprises a control unit that is fed with power by the outer transformer through a voltage regulator.

The mixer 1 also comprises a removable battery to keep the functionality of the electronic control board even in the case of a lack of main power. A circuit portion intended to regulate the power supply coming from the battery is foreseen on the electronic control board 24.

The electronic control board 24 comprises a microcontroller with integrated circuit comprising a plurality of command outlets to enable respective bridge or half-bridge outlet stages of power transistors to command the electric motors 19, 18 of the valves 7, 6.

Should it not be clear from the previous description, the shower head that can be connected to the mixer 1 according to the present invention can keep the known mechanical structure that allows the dispensing of the flow of water to be switched from centralized dispensing through a central nozzle that dispenses a cohesive flow to rain-type perimetrically diffused dispensing through a plurality of small nozzles arranges in a ring around the central nozzle.

This possibility of manually switching the dispensing of fluid does not interfere in any way with the electric command solution illustrated previously that concerns the possibility of regulating the opening and closing of the water flow as well as the temperature and flow rate regulation.

Indeed, the mixer 1 foresees the possibility of mixing the water in temperature and flow rate and of conveying the water towards the shower head through a single supply pipe. In this case the switching from peripheral jet to central jet and vice-versa is carried out manually and mechanically through the shower head.

Nevertheless, it is clear that the mixer 1 according to the invention also foresees the possibility of switching the dispensing of the flow of water centrally or peripherally from the body of the diffuser through an electric command.

In this variant embodiment the electrical switching is not obtained through a simple transformation of the known mechanical manual command, but rather through the control of the interceptors 11, 41 of the interception group 8.

In particular, the electrovalves 11, 41 for intercepting fluid are situated in the interception group immediately downstream of the outlet 5. Each of the two electrovalves 11, 41 is situated upstream of a respective flexible pipe for supplying fluid towards the jet spray.

More specifically, the two corresponding flexible supply pipes are coupled longitudinally and parallel to each other to form a single flexible hydraulic connection towards the jet spray.

Even more specifically, a first flexible pipe is in communication with the central nozzle for dispensing the cohesive fluid, whereas a second flexible pipe is in fluid communication with the plurality of perimetric nozzles arranged in a ring around the central nozzle in the jet spray.

In this variant embodiment it is also foreseen for the electrical connection that runs inside the protective sheath of the flexible hydraulic connection to lead to a corresponding electrical switching command or button of the dispensing mounted on the dispensing jet. Moreover, each of the two interception electrovalves is electrically connected to the electronic control board 24 that incorporates a circuit portion intended to control the electrovalves 11, 41.

In the electronic control board 24 there is a connection with a temperature sensor 31 installed for example near to the outlet of the mixer 1 or near to the electrovalves 11, 41. Such a temperature sensor 31 is associated with a display 34 that allows the user to also view the temperature of the water flow being dispensed.

By simply pressing a button on the jet spray the user switches the dispensing of fluid from the central nozzle to the peripheral nozzles, and vice-versa, by means of the closing of just one of the two electrovalves 11 or 41. In other words, pressing on the buttons controls the switching open and closed of the two electrovalves 11, 41, so that when one of them is opened, the other is kept closed.

A wireless connection can be foreseen between the commands of the jet spray and the electronic control board 24. It is foreseen to equip the jet spray with a transmitter of radio frequency signals and the electronic control board 24 of a receiver of such radio frequency signals. In this case a power supply battery for the signal transmitter is also foreseen on board the jet spray.

From the previous description it can clearly be seen that the mixer according to the invention solves the technical problem and achieves numerous advantages.

The invention makes the presence of a mechanical command lever associated with the support tap of the jet spray totally superfluous.

Moreover, the command and regulation of the water flow is simple and effective to the point of making the act of holding the jet spray the only manual action necessary to dispense the flow of fluid.

Advantageously, the mixer encloses in a small-sized box-shaped housing all of the mechanical and electrical components necessary to regulate not only the temperature and the flow of water but also the mode of dispensing.

In particular, the mixer can easily be installed at a shower panel, for example in a small seat of the shower panel, or built into a seat in the wall behind the shower panel, but it can also easily be installed under a kitchen or bathroom sink or in a bathtub.

Advantageously, the mixer can be regulated directly through a user interface directly mounted on a front part of the coating or it can be regulated through commands directly associated with the jet spray or with the shower panel and electrically connected to the electronic control board of the mixer.

Advantageously, the mixer allows the fluid to be supplied through a single pipe associated with a single outlet and is compatible with known jet sprays that foresee controlling the mode of dispensing through the jet spray itself.

Moreover, the mixer allows the fluid to be supplied through two outlets associated through two flexible pipes with two different dispensing seats of the jet spray, foreseeing to control the mode of dispensing electronically through the mixer.

Advantageously, the mixer allows the fluid to be supplied through two or more outlets associated through respective flexible pipes, for example, with a jet spray, with a central ring and with a hydromassage jet of a shower, foreseeing to control the outlet of water electronically through the mixer towards the jet spray, the ring or the hydromassage jet.

Advantageously, the installation of the mixer at a shower panel, at a bathtub or at a washbasin is unusually simple and foresees the connection of the hydraulic pipes going into and out from the mixer and an electrical connection thereof to an electrical power socket.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A mixer for a jet spray, comprising:
a regulator equipped with a hot water inlet, a cold water inlet a mixed water outlet and a pair of shutters arranged between the mixed water outlet and, respectively, the hot water inlet and the cold water inlet;
motorized means for actuating the shutters;
an interception assembly, comprising a manifold engaged axially with the outlet of the regulator, at least one outlet, and an interceptor for blocking and unblocking the supply of water towards the outlet; and
a substantially box-shaped outer housing comprising holes at which the inlets of the regulator and the outlet of the interception assembly are positioned for hydraulic connection of the hot and cold water inlets and the outlet to respective hydraulic pipes.

2. The mixer according to claim 1, further comprising electric motors for actuating a respective shutter having a rotation shaft mounted axially and fixedly to a rotation pin of the shutter.

3. The mixer according to claim 2 wherein said electric motors comprise a ratio motor.

4. The mixer according to claim 1, further comprising electric motors for actuating a respective shutter, coupled with said shutters through reducing gears.

5. The mixer according to claim 4, further comprising a magnet mounted axially on a reducing gear and a control sensor fixed firmly with respect to the housing, near to the magnet, to control the angular displacement of the shaft according to the detection of magnetic poles of the magnet.

6. The mixer according to claim 1, further comprising a turbine arranged between the outlet of the regulator and the manifold of the interception assembly, comprising a plurality of blades associated with a respective magnet, and a flow sensor, coupled fixedly to the housing, near to the turbine, to detect a frequency of rotation of the turbine according to the detection of the magnets associated with the blades.

7. The mixer according to claim 1 wherein said interception assembly further comprises a temperature sensor comprising a ceramic plate having a surface on which a temperature measurer is fixed and an opposite surface positioned to contact the mixed water.

8. The mixer according to claim 1 wherein said interceptor is an on-off safety electrovalve.

9. The mixer according to claim 1 wherein said interception assembly, comprises at least one second outlet and at least one second interceptor for blocking and unblocking the supply of water towards the second outlet.

10. The mixer according to claim 9 wherein said first interceptor and said second interceptor are on-off electrovalves actuated, selectively, to unblock the supply of water towards the respective outlet, or simultaneously to block the supply of water from the manifold.

11. The mixer according to claim 1, further comprising a power supply battery and an electronic control board electrically connected to the electric motors, the control sensors, the temperature sensors, the flow sensors and the battery.

12. The mixer according to claim 11, further comprising a user interface for commanding said regulator and said interception assembly, electrically connected to the electronic control board.

13. The mixer according to claim 12 wherein said control sensor is fixed to the electronic control board.
